(19) United States
(12) Patent Application Publication
(10) Pub. No.: US 2011/0113748 A1
(43) Pub. Date: May 19, 2011

(54) GUIDING AN IGNITION SPARK PLUG IN A TURBOMACHINE COMBUSTION CHAMBER

(75) Inventors: Dominique Maurice Jacques LAINS, Melun (FR); Nicolas Christian Raymond Leblond, Lieusaint (FR); Christophe Pieussergues, Nangis (FR)

(73) Assignee: SNECMA, Paris (FR)

(21) Appl. No.: 12/946,253

(22) Filed: Nov. 15, 2010

(30) Foreign Application Priority Data
Nov. 18, 2009 (FR) 09 05539

(51) Int. Cl. F02C 7/266; F02C 1/00

(52) U.S. Cl. 60/39.827; 60/722

(57) ABSTRACT

The invention relates to a turbomachine combustion chamber including at least one ignition spark plug carried by an outer casing and extending in guide means carried by a wall of the chamber, the wall forming a body of revolution, the guide means comprising a tubular guide having the spark plug passing axially therethrough and mounted with axial and transverse clearance on a chimney fastened to the wall of the chamber and opening out into the chamber. In order to reduce wear of the spark plug in operation, the spark plug is mounted by being fastened in a sheath, the tubular guide being slidably mounted around the sheath.

### FIELD OF THE INVENTION

The present invention relates essentially to guiding an ignition spark plug in an annular combustion chamber of a turbomachine such as an airplane turboprop or turbojet.

### BACKGROUND OF THE INVENTION

An annular combustion chamber of a turbomachine comprises an annular chamber end wall that is connected to two substantially circularly cylindrical shrouds that are coaxial and that extend downstream, together with a fairing or covering fastened on the chamber end wall and extending upstream.

The fairing guides the flow of air delivered by the turbomachine compressor and shares it between a central stream feeding the combustion chamber and two peripheral streams flowing past the combustion chamber.

The air from the compressor is taken into the combustion chamber and mixed with fuel, the mixture being ignited by means of at least one ignition spark plug mounted on an outer casing and passing through an orifice in the outer shroud.

In order to provide the combustion chamber with sealing at this orifice, it is known to mount guide means in the orifice, which guide means comprise a guide tube having the spark plug passing axially therealong and mounted with axial and transverse clearance on a chimney that is fastened to the outer shroud of the combustion chamber and that opens out into the combustion chamber via the above-mentioned orifice.

The clearance allows axial and radial movements to take place between the combustion chamber and the outer casing as a result of their differential expansion during different stages of flight, without causing the spark plug to come into abutment against or to press against the edges of the orifice in the outer shroud of the combustion chamber.

Functional clearance also exists between the spark plug and the guide so as to allow the guide to be moved in translation relative to the spark plug.

The guide extends in a peripheral stream defined by the outer casing and by the combustion chamber, such that the air flowing in said stream presses the guide against the spark plug. Contact between the cylindrical inside surface of the guide and the cylindrical outside surface of the spark plug takes place on the side that is upstream relative to the air flow.

Since the dimensions of the contact zone are small, the contact pressure or Hertz pressure is high.

In addition, vibration, and the above-mentioned air flow tend to cause the guide to turn around the spark plug.

This gives rise to premature wear of the spark plug in its zone that makes contact with the guide.

### OBJECT AND SUMMARY OF THE INVENTION

A particular object of the invention is to provide a solution to this problem that is simple, effective, and inexpensive.

To this end, the invention provides a turbomachine combustion chamber including at least one ignition spark plug carried by an outer casing and extending in guide means carried by a wall of the chamber, the wall forming a body of revolution, the guide means comprising a tubular guide having the spark plug passing axially therethrough and mounted with axial and transverse clearance on a chimney fastened to the wall of the chamber and opening out into the chamber, wherein in order to reduce wear of the spark plug in operation, the spark plug is mounted by being fastened in a sheath, the tubular guide being slidably mounted around the sheath.

In this way, the tubular guide does not subject the spark plug to wear but instead subjects the sheath to wear, where the sheath is a part that is inexpensive and easy to replace.

In an embodiment of the invention, the sheath is fastened to the outer casing, e.g. by screw-fastening.

At least a portion of the sheath extends into the air flow stream outside the combustion chamber and includes holes for cooling the spark plug.

According to a characteristic of the invention, the sheath includes a radially outer end having an annular collar for bearing against an element carried by the outer casing.

The collar then forms an abutment that makes it easier to position the sheath.

In practice, the annular collar includes flats in its periphery. This enables the sheath to be gripped by a tool, e.g. in order to screw it into an adapter of the casing.

In a preferred embodiment of the invention, at least one cooling opening for cooling the spark plug is formed in the chimney, the radially inner end of the sheath not extending up to said opening so as to allow the spark plug to project and enable it to be cooled.

According to a characteristic of the invention, the spark plug is fastened in the sheath by screw-fastening.

Advantageously, the sheath includes extra thickness in its portion located between the spark plug and the guide.

By way of example, the extra thickness may lie in the range 50% to 150%.

The invention also provides a turbomachine such as an airplane turboprop or turbojet that includes an annular combustion chamber of the invention.

### BRIEF DESCRIPTION OF THE DRAWINGS

The invention can be better understood and other details, characteristics, and advantages of the invention appear on reading the following description made by way of non-limiting example with reference to the accompanying drawings, in which:

FIG. 1 is a longitudinal section view of a portion of an annular combustion chamber in the prior art;

FIG. 2 is a perspective view of a portion of the FIG. 1 annular combustion chamber;

FIG. 3 is an enlarged view of the means for guiding a spark plug as used in the chamber of FIGS. 1 and 2;

FIG. 4 is an enlarged view in section of a combustion chamber of the invention, the spark plug and the sheath not being shown;

FIG. 5 is a perspective view of the sheath;

FIG. 6 is a view in perspective and in midplane section of the FIG. 5 sheath; and

FIG. 7 is a midplane section view showing the spark plug and the sheath mounted in the combustion chamber of the invention.

### MORE DETAILED DESCRIPTION

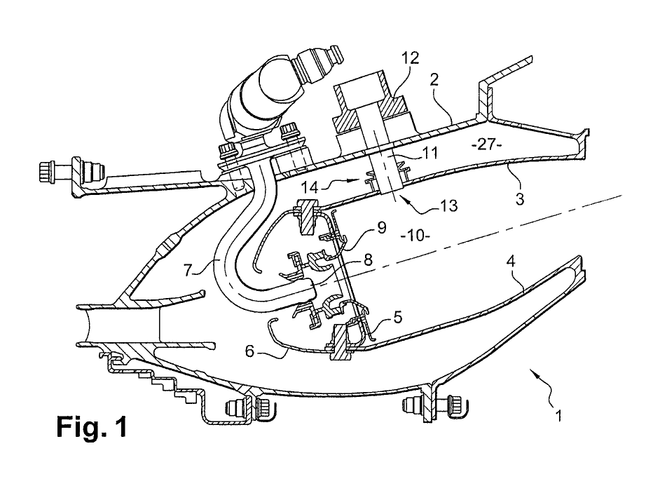

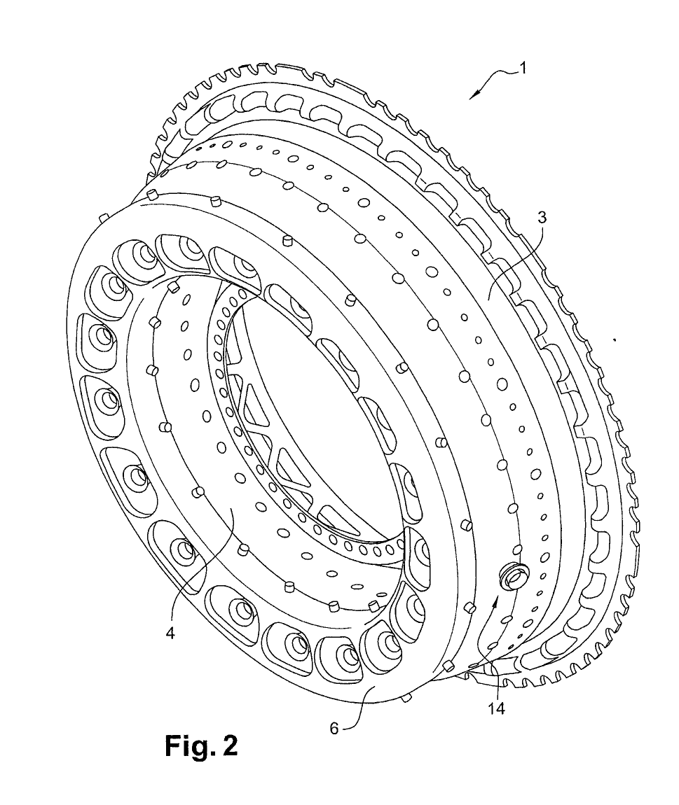

As shown in FIGS. 1 and 2, an annular combustion chamber 1 of a turbomachine such as an airplane turboprop or turbojet is mounted in an outer casing 2 and includes an outer shroud 3 forming a body of revolution having a downstream annular flange for fastening to the casing 2, an inner shroud 4 forming a body of revolution having a downstream annular flange for mounting to an inner casing, and a chamber end wall 5 having fairings 6 mounted thereon that extend upstream.

Fuel injector pipes 7 distributed around the axis of the turbomachine open out into the chamber end wall 5 via injector heads 8. Injector systems 9 are disposed around each injector head 8.

The flow of air delivered by the compressor of the turbomachine is guided by the fairings 6 and shared between a central stream for feeding the combustion chamber 1 and two peripheral streams for flowing around the combustion chamber.

The injector systems 9 form turbulent incoming air flows in a primary combustion zone 10 of the combustion chamber 1. This air is mixed with fuel sprayed by the injector head 8, the mixture being ignited by at least one spark plug 11.

The outer end of the spark plug 11 is mounted in an adapter 12 that is fastened to the outer casing 2. The inner end of the spark plug 11 passes through an orifice 13 formed in the outer shroud 3 so as to be flush with the inside surface of the outer shroud 3.

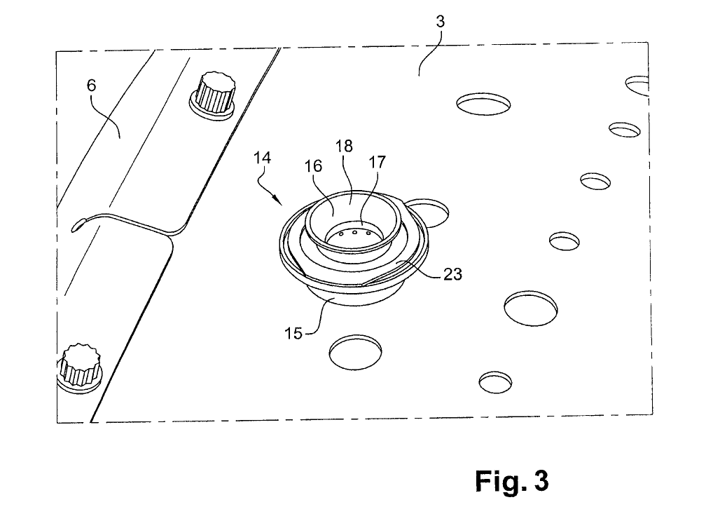

The orifice 13 is fitted with guide means 14 for guiding the spark plug 11 and comprising a tubular chimney 15 (see FIG. 3) that is fastened to the outer shroud 3 and that opens into the chamber 10 via said orifice 13, and by a guide 16 surrounding the spark plug and mounted with axial and transverse clearance on the chimney 15. A portion of the guide extends in the air flow stream situated outside the chamber. As mentioned above, the air flowing in this stream pushes the guide against the spark plug under the effect of vibration in operation and tends to cause the air to turn around the spark plug.

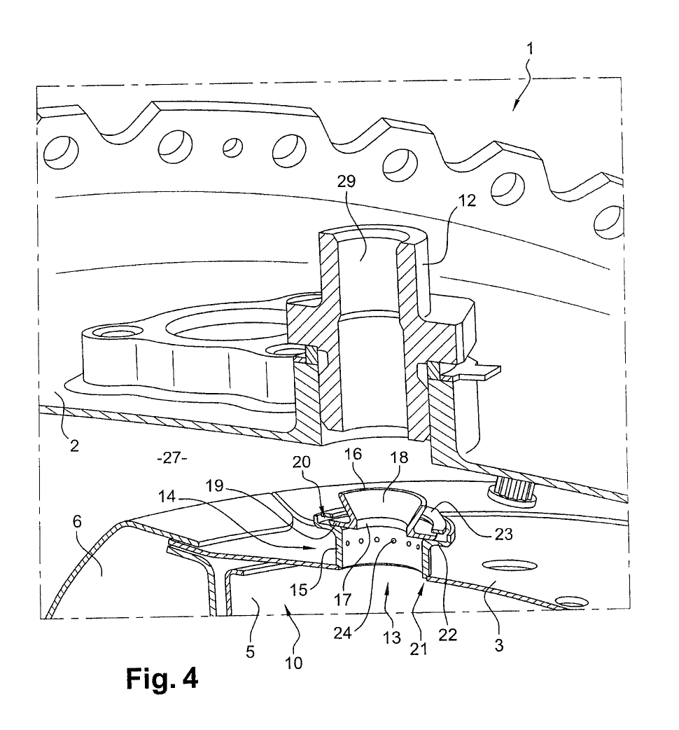

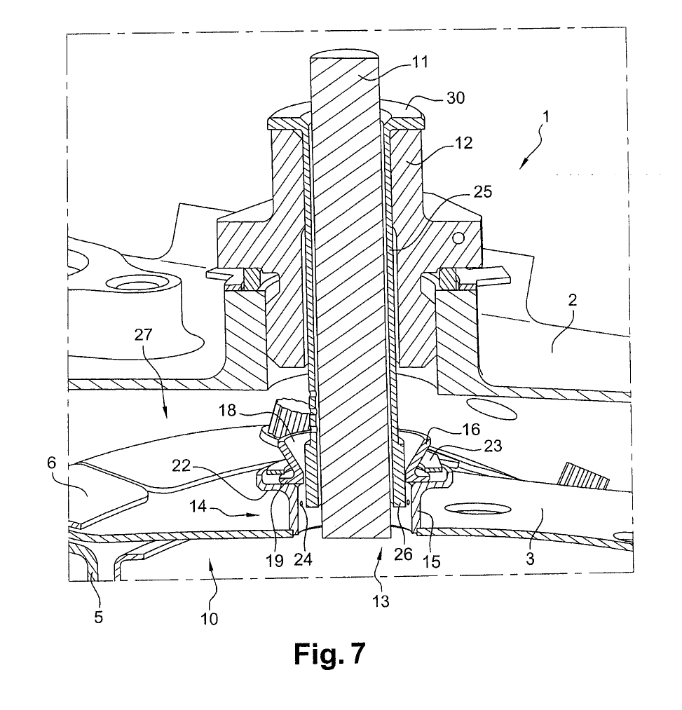

The guide means of a combustion chamber of the invention are shown in FIGS. 4 and 7.

These means comprise a guide 16 having a cylindrical inside surface 17 for surrounding the spark plug 11 and connected at its end beside the outer casing 2 to a frustoconical surface 18, and at an opposite end to an annular collar 19 for being engaged with clearance in an inner annular groove 20 of the chimney 15.

The chimney is generally tubular in shape and circular in section. A radially inner end 21 of the chimney 15 is mounted in and welded to the shroud 3 via a shoulder that bears against the edge of the orifice 13 and facilitates positioning the chimney 15.

The outer end of the chimney includes an annular rim 22 extending radially outwards relative to the axis of the chimney and having fastened thereon an annular plate 23 that extends parallel to the rim 22 and that co-operates therewith to define the inner annular groove 20.

The collar 19 of the guide extends in the annular groove 20, with radial clearance being formed between the peripheral edge of the collar 19 and the bottom of the groove 20, axial clearance also being formed between the collar 19 and the annular wall 23.

These clearances and the sliding of the spark plug 11 in the guide 16 serves to compensate for the relative offsets and movements between the spark plug 11 and the chimney 15 as caused by the expansion due to the high temperatures that appear while the turbomachine is in operation.

Cooling holes 24 are formed in the wall of the chimney 15 and they are regularly disposed along a circle situated between the rim 22 and the inner end 21 of the chimney 15.

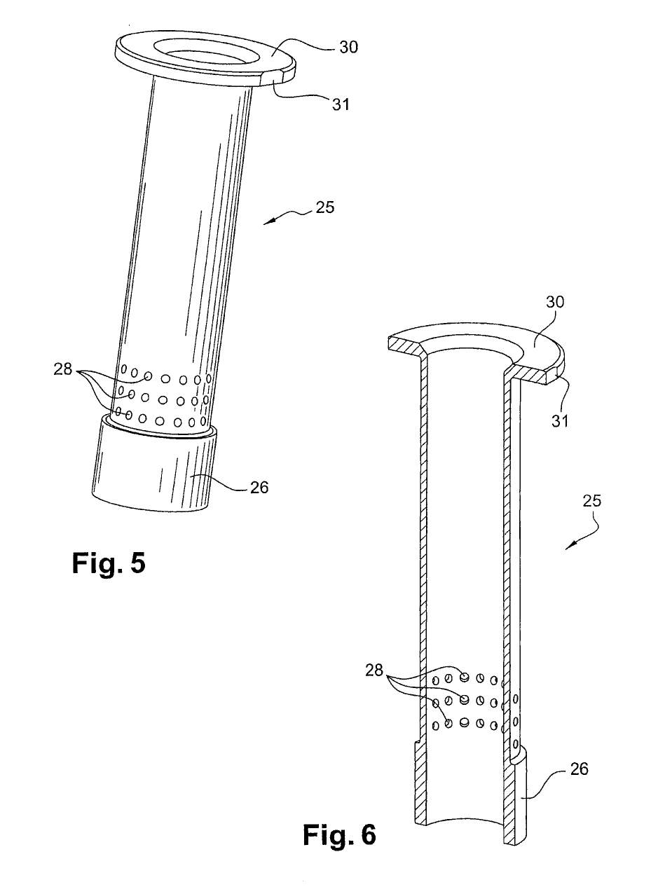

According to the invention, a tubular sheath 25 is slidably mounted in the guide around the spark plug. As can be seen better in FIGS. 5 and 6, the sheath 25 includes outer extra thickness 26 at its radially inner end situated inside the guide, with the cylindrical inner wall 17 thereof coming in operation to bear against said extra thickness. The height of the extra thickness 26 is approximately equal to the height of the guide.

The radially inner end of the sheath 25 is situated below the cooling openings 24 so as to allow the spark plug 11 to project and enable it to be cooled.

The sheath 25 also has a middle portion extending through the airflow stream 27 outside the chamber and the guide 16, this portion including cooling holes 28 for cooling the spark plug 11. These holes 28 are arranged in three rows, in the embodiment shown in FIGS. 5 to 7.

The radially outer end of the sheath 25 is screw-fastened to the adapter 12 of the outer casing 2.

More precisely, the adapter 12 is fastened to the outer casing 2 and includes an axial passage having a tapped portion 29 that co-operates with a threaded portion of the sheath 25.

The radially outer end of the sheath 25 is provided with an annular collar 30 that bears against the corresponding end of the adapter after screw-tightening.

The annular collar 30 includes flats 31 at its periphery so as to make it easy to turn the sheath 25 with a wrench.

The radially outer end of the sheath 25 also includes inner tapping co-operating with a thread on the spark plug 11, the spark plug thus being screwed into the sheath 25.

In operation, the air flowing in the peripheral stream 27 presses the guide 16 against the extra thickness 26 of the sheath 25, with the vibration and rotation of the guide 16 progressively wearing down this extra thickness. The spark plug 11, protected by the sheath 25, does not suffer any damage. Only the sheath 25 is worn down by the guide 16, and it is inexpensive and easy to replace. By way of example, the extra thickness 26 constitutes about 50% to 150% of the thickness of the remainder of the sheath. It increases the lifetime of the sheath considerably.

Furthermore, the use of a sheath 25 does not disturb the operation of the guide means 14. The axial and radial clearances provided between the guide 16 and the chimney 15 enable any offset or shifting of the axis of the sheath 25 and of the spark plug 11 relative to the axis of the chimney 15 to be compensated while providing good sealing for the combustion chamber at the orifice 13.

What is claimed is:

1. A turbomachine combustion chamber including at least one ignition spark plug carried by an outer casing and extending in guide means carried by a wall of the chamber, the wall forming a body of revolution, the guide means comprising a tubular guide having the spark plug passing axially therethrough and mounted with axial and transverse clearance on a chimney fastened to the wall of the chamber and opening out into the chamber, wherein in order to reduce wear of the spark plug in operation, the spark plug is mounted by being fastened in a sheath having at least a portion thereof extending in an airflow stream outside the chamber and including holes for cooling the spark plug, the tubular guide being slidably mounted around the sheath.

2. A combustion chamber according to claim 1, wherein the sheath is fastened to the outer casing, e.g. by screw-fastening.

3. A combustion chamber according to claim 1, wherein the sheath includes a radially outer end having an annular collar for bearing against an element carried by the outer casing.

4. A combustion chamber according to claim 3, wherein the annular collar includes flats in its periphery.

5. A combustion chamber according to claim 1, wherein at least one cooling opening for cooling the spark plug is formed in the chimney, the radially inner end of the sheath not extending up to said opening so as to allow the spark plug to project and enable it to be cooled.

6. A combustion chamber according to claim 1, wherein the spark plug is fastened in the sheath by screw-fastening.

7. A combustion chamber according to claim 1, wherein the sheath includes extra thickness in its portion located between the spark plug and the guide.

8. A combustion chamber according to claim 7, wherein the extra thickness lies in the range 50% to 150% of the thickness of the remainder of the sheath.

9. A turbomachine such as an airplane turboprop or turbojet including an annular combustion chamber according to claim 1.
